(19) United States
(12) Patent Application Publication
(10) Pub. No.: US 2011/0282712 A1
(43) Pub. Date: Nov. 17, 2011

(54) SURVEY REPORTING

(76) Inventors: Michael Amos, Caledon (CA); Sandra Tamburino, Toronto (CA)

(21) Appl. No.: 12/777,587

(22) Filed: May 11, 2010

(51) Int. Cl. G06Q 10/00; G06Q 90/00

(52) U.S. Cl. 705/7.32; 705/500

(57) ABSTRACT

A method is described for presenting a report. The method comprises the following steps. Survey results are obtained to plurality of customer surveys for a predefined location over a data accumulation period. Each customer survey includes a plurality of attributes each having at least one weighting factor. A location average result is calculated for each of the plurality of attributes. Survey results are obtained to a plurality of peer surveys over the data accumulation period for at least one corresponding peer. Each peer survey including a plurality of attributes. Calculating a peer average result for each of the plurality of attributes. A peer difference score is determined for each of the attributes as a difference between the location average result and the peer average result for the corresponding attribute. A ranking score is determined for each attribute based on a combination of the at least one weighting factor and the peer difference score. The ranking score is used to determine a priority in which to present the attributes in the report.

The present invention relates generally to customer surveys and specifically to a system and method for providing improved reporting of results for such survey.

### BACKGROUND

Many companies value surveys, such as employee evaluation and customer satisfaction surveys. Companies use such surveys to judge performance and for award recognition and employee rewards, for example. Companies also use customer satisfaction surveys to gauge success of products or services and determine improvements.

Surveys may help initiate changes in a workplace environment, to product or service improvements, and to employee training Survey results may influence major strategic decisions by a corporation. Nonetheless, current survey systems do not provide a sufficient analysis of the survey responses to help in making important, timely business decisions, particularly at the individual location level in a multi-unit chain.

Therefore, a system that provides improved analysis of the survey responses that better helps companies understand the survey results is highly desirable.

### SUMMARY

Accordingly, an aspect of the present invention provides a method for presenting a tailored report, the method comprising the steps of: obtaining survey results to a plurality of customer surveys for a predefined location over a data accumulation period, each customer survey including a plurality of attributes each having at least one weighting factor; calculating a location average result for each of the plurality of attributes; obtaining survey results to a plurality of peer surveys over the data accumulation period, each peer survey including a plurality of attributes; calculating a peer average result for each of the plurality of peer attributes; determining a peer difference score for each of the customer attributes as a difference between the location average result and the peer average result for the corresponding attribute; determining a ranking score for each attribute based on a combination of at least one weighting factor and the peer difference score; and using the ranking score to determine a priority in which to present the attributes in a report. The final report provided to the user can combine multiple selection methods in one report (for example, two location-specific prescriptions and one static brand focus attribute).

### BRIEF DESCRIPTION OF THE DRAWINGS

The following embodiments will now be described by way of example only with reference to the following drawings in which:

FIG. 1 is a flow chart illustration a method for generating and prioritizing data to be presented in a report; and

FIG. 2 is a screenshot of a sample report generated from the method of FIG. 1.

### DETAILED DESCRIPTION OF THE PREFERRED EMBODIMENTS

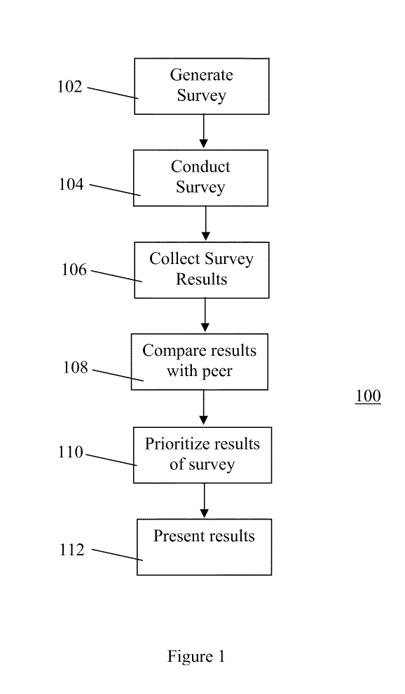

For convenience, like numerals in the description refer to like structures in the drawings. Referring to FIG. 1, a flow chart illustrating an overview for creating a survey and generating a report in accordance with the present embodiment is illustrated generally by numeral 100.

At step 102, a survey is generated. In the present embodiment, the survey comprises a questionnaire that is configured to pose specific questions to customers to obtain feedback about a service. For the purpose of this description, the term “customers” is used to refer to a consumer that uses a service such as purchasing an item at a retail store or eating at a restaurant. Further, the term “product” is used to refer to a service, brand, experience and/or merchandise. For example, the product could be the service provided by a store, merchandise sold at the store, or a combination thereof.

At step 104, the survey is presented to the customers for a particular location, and their responses are collected on an ongoing basis. For the purpose of this description, the term “location” is used to refer to a business or particular storefront within a multi-store business chain. At step 106, the survey responses are collected over a period of time.

At step 108, the results of the survey responses for a predefined data accumulation duration are compared with an average of survey results collected for the product's peers. That is, the results of the survey responses are compared with survey results for a set of predefined peers, which are collected concurrently with the survey responses for the product.

The term “peer” is used to refer to a comparable product. The peer may be a competitor's product or a related product. For example, if the product is a store, the peers are selected based on similarity in characteristics such store format, size, location type, or channel mix, and the like. The peers may be competing stores or different locations of a chain of stores.

At step 110, the results of the survey responses are prioritized based at least in part, on category, a predefined weighting factor and the results of the comparison with the peers. At step 112, the survey responses are displayed to a review using the priorities determined at step 110.

The method outlined above will now be described in greater detail. At step 102, in order to generate a survey, a weighted importance is determined for a series of attributes on business outcomes, such as satisfaction, recommendation and intent to return, based on a Structural Equation and/or Path Analytical Model. Structural equation modeling (SEM) is a statistical technique for testing and estimating causal relationships using a combination of statistical data and qualitative causal assumptions. Path Analysis is a special case of SEM used to describe the directed dependencies among a set of variables. Both SEM and Path Analysis are well known in the art and need not be described in detail.

Some examples of attributes for a restaurant include cleanliness of restaurant, cleanliness of menu, cleanliness of restrooms, menu selection, quality of service, speed of service, friendliness of service and so on and so forth. In the present embodiment, these “importances” inform the attributes for an ongoing customer satisfaction survey instrument. That is, the customer satisfaction survey questions are selected and/or prioritized, at least in part, based on their weighted importance.

An influence weight and a business weight are assigned for each of the attributes. In the present embodiment, the influence weight represents the importance of the question as it relates to a specific business outcome. For example, continuing the restaurant example, consider the business outcome of satisfaction. The response regarding cleanliness of the menu will be weighted differently than response regarding cleanliness of the restrooms in terms of affecting customer satisfaction as they have a different impact on the customer.

To accommodate for client business priorities, each attribute set is also categorized into one of a plurality of predefined business attributes. In the present embodiment, there are two business attributes, which are “functional” attributes and “emotional” attributes. Thus, each of the attributes is categorized as either functional or emotional. Referring again to a restaurant example, questions regarding cleanliness of the restaurant can be categorized as functional whereas questions regarding customer's experience at the restaurant can be categorized as emotional. For example, a functional question can be quantitative such as “Were the bathrooms clean?” An emotional question can be qualitative such as “Did the staff make you feel like a valued customer?”

The business attributes provide business weights that can further be used to weight the attributes. Depending on the client business priorities, the business weights add to or remove from the relevance of the questions. In the present embodiment, the client business priorities favour functional responses over emotion responses. Thus, the business weights for attributes identified as functional are higher than those identified as emotional. In the present embodiment, the business weight for the functional attributes are defined as 1/(total # of attributes)*2. Thus, for example, for a forty-attribute survey, each of the functional attributes would receive a business weight of 1/40*2=0.05. In contrast, the business weight for the emotional attributes are defined as 1/(total # of attributes). Thus, continuing the example of a forty-attribute survey, each of the emotional attributes would receive a business weight of 1/40=0.025.

In an alternate embodiment, however, emotional responses may be favoured over functional responses and those attributes categorized as emotional would be weighted higher. Further, different weighting algorithms may also be used to emphasize the difference between business attributes.

At step 104, the survey is presented and the results are collected on an ongoing basis. The survey can be presented using traditional media such as form-fillable survey cards or using electronic media, such as at a kiosk, website, custom application, mobile device or the like. As will be appreciated a number of known and proprietary exist for providing a user with a customer survey and most, if not all, can be used herein.

At step 106, the survey responses are collected over time. In the present embodiment, the survey results are based on a data accumulation period of three months of data. Accordingly, once three months of data from the customer surveys described in step 102 have been collected, a three-month average score is determined, as will be described below. Once the three-month threshold has been passed, the average score can be updated at predetermined intervals, such as monthly, quarterly, semi-annually, or the like. Alternately, average score can be updated “on-demand”. As will be appreciated, the frequency at which the average score is calculated and the duration of the data accumulation period can vary depending on the implementation. For example, the duration of the data accumulation period can be shorter for a high volume of survey responses and longer for a low volume of survey responses.

At step 108, the results of the survey responses are compared with results for the location's peers. In the present embodiment each location is assigned to a group of locations based on a number of factors, such as geography, trade area, format, channel mix and the like. The other locations in this group are considered to be the location's peers. The peer groups can be managed dynamically as new locations are added and as existing locations change factors used for determining a peer group.

The results of the surveys are compared by calculating an average score for each attribute in the survey of the data accumulation period and comparing the average store for the location to the average score of its peers. A mathematical comparison determines peer difference score that is a difference between each location's attribute average score and that of the average attribute score of the location's peers. In the present embodiment, a peer difference score is an absolute difference and is determined for each attribute.

At step 110, the results of the survey responses are prioritized as follows. A ranking score for each attribute average score is calculated by multiplying the influence weight by the business weight and the peer difference score for each attribute. All attributes for the location are rank ordered from highest to lowest based on their ranking score. Accordingly, it will be appreciated that the highest ranked attributes reflects the attributes of highest importance and highest mathematical difference from the location's peers.

At step 112, the results of the survey are displayed to the customer in a report based in part upon the ranking score. The number of attributes to be displayed in the report can vary. In the present embodiment, the number of attributes displayed is in the order of three to five. In the present embodiment, the report is organized in a plurality of different stages each having a plurality of different focus areas. The focus areas in different stages may overlap. Further, the attributes from the survey are assigned to corresponding focus areas. Accordingly, the number of attributes to display in a report may depend, at least in part, on the attributes and how they relate to each focus area as well as each stage.

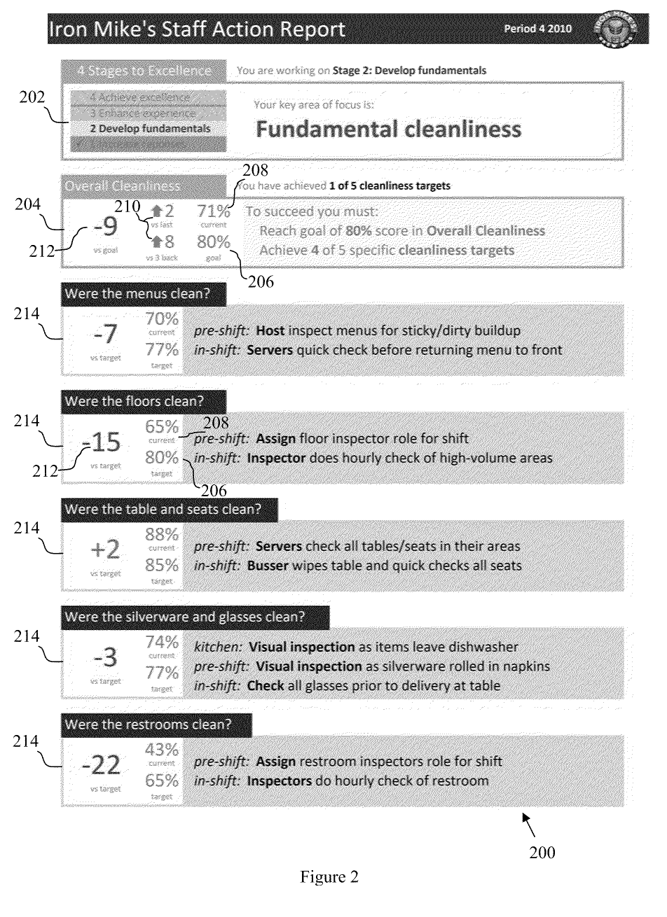

Referring to FIG. 2, a sample report is illustrated generally by numeral 200. In the present embodiment, four different stages 202 are identified for the location to improve performance. Once each stage 202 reaches a predefined target, the customer can move on to the next stage. In the present example, the four stages 202 include Increase Responses, Develop Fundamentals, Enhance Experience, and Achieve Excellence. Further, in this example, the location has completed the Increase Responses stage and is working on the Develop Fundamentals stage.

Each stage may include a plurality of different focus areas. Examples of different focus areas include Cleanliness, Food Quality, and Service, Atmosphere, Recommendations and Friendliness. The Develop Fundamentals stage includes the focus areas of Cleanliness, Food Quality, and Service. Similarly to the different stages, the customer is presented with a single focus area until a predefined target is achieved.

As illustrated in FIG. 2, an overall target box 204 is provided for the focus area of Cleanliness. The overall target box 204 includes a goal indicator 206, a current level indicator 208, previous performance comparators 210 and a target comparator 212. The goal indicator 206 illustrates the target for the overall cleanliness results. Overall cleanliness is the average score for all attributes relating to cleanliness. The current level indicator indicates the current average overall cleanliness results. One of the previous performance comparators 210 indicates a comparison with the overall cleanliness results from a report immediately prior and the other of the previous performance comparators 210 indicates a comparison with the overall cleanliness results from a report several reports prior. The target comparator 212 provides a visual reference of the difference between the current level of overall cleanliness and the target level of overall cleanliness.

Further, a plurality of an attribute target boxes 214 are provided for the focus area of Cleanliness. Each attribute target box 214 displays statistics for an attribute that relates to cleanliness. Each attribute target box 214 includes a goal indicator 206, a current level indicator 208 and a target comparator 212. The number of attribute boxes 214 to be displayed depends on the configuration of the report. To support this process, there is a dynamic list of diagnostic attributes that support sub-stages or focus areas. For example, if “Basic Fundamentals” is a stage, then a sub-stage could be “Fundamental Cleanliness”, or “Fundamental Hospitality”, or “Fundamental Product Quality”. Depending on the sub-stage, a set of diagnostic attributes will be displayed. The sub stage of Cleanliness might have three diagnostics whereas Hospitality could have five or more. The displayed attributes are defined by the location focus area.

The order in which the attributes are to be displayed depends on the ranking score of the corresponding attribute. If there are more attributes than attribute boxes, only the highest ranked attributes are displayed.

In the present embodiment, the report may also provide links to an online Best Practice library to assist the location in improving the results of the survey. A further Diagnostic Prescriptive Report can also be provided, with a defined list of behaviours to clarify what specific actions need to be manifested to positively impact the scores for their prescriptive issues requiring attention.

Using the foregoing specification, the invention may be implemented as a machine, process or article of manufacture by using standard programming and/or engineering techniques to produce programming software, firmware, hardware or any combination thereof.

Any resulting program(s), having computer-readable program code, may be embodied within one or more computer-usable media such as memory devices or transmitting devices, thereby making a computer program product or article of manufacture according to the invention. As such, the terms “software” and/or “application” as used herein are intended to encompass a computer program existent (permanently, temporarily, or transitorily) on any computer-usable medium such as on any memory device or in any transmitting device.

Examples of memory devices include, hard disk drives, diskettes, optical disks, magnetic tape, semiconductor memories such as FLASH, RAM, ROM, PROMS, and the like. Examples of networks include, but are not limited to, the Internet, intranets, telephone/modem-based network communication, hard-wired/cabled communication network, cellular communication, radio wave communication, satellite communication, and other stationary or mobile network systems/communication links.

A machine embodying the invention may involve one or more processing systems including, for example, CPU, memory/storage devices, communication links, communication/transmitting devices, servers, I/O devices, or any subcomponents or individual parts of one or more processing systems, including software, firmware, hardware, or any combination or subcombination thereof, which embody the invention as set forth in the claims.

Using the description provided herein, those skilled in the art will be readily able to combine software created as described with appropriate general purpose or special purpose computer hardware to create a computer system and/or computer subcomponents embodying the invention, and to create a computer system and/or computer subcomponents for carrying out the method of the invention.

What is claimed is:

1. A method for presenting a report, the method comprising the steps of:
obtaining survey results to plurality of customer surveys for a predefined location over a data accumulation period, each customer survey including a plurality of attributes each having at least one weighting factor;
calculating a location average result for each of the plurality of attributes;
obtaining survey results to a plurality of peer surveys over the data accumulation period for at least one corresponding peer, each peer survey including a plurality of attributes;
calculating a peer average result for each of the plurality of attributes;
determining a peer difference score for each of the attributes as a difference between the location average result and the peer average result for the corresponding attribute;
determining a ranking score for each attribute based on a combination of the at least one weighting factor and the peer difference score; and
using the ranking score to determine a priority in which to present the attributes in the report.

2. The method of claim 1, wherein the at least one weighting attribute includes an influence weight configured to weight the attribute in accordance with its importance.

3. The method of claim 2, wherein the influence weight is determined based one or both of a Structural Equation or Path Analytical Model.

4. The method of claim 1, wherein the at least one weighting attribute includes a business weight configured to weight the customer attribute in accordance with a predefined business attribute.

5. The method of claim 4, wherein the business attributes are categorized as either a functional attribute or an emotional attribute.

6. The method of claim 1, wherein the data accumulation period is three months.

7. The method of claim 1, wherein the attributes are organized into a plurality of different focus areas and the attributes within one of the plurality of focus areas are presented based on the determined priority.

8. The method of claim 1, wherein a predefined number of the attributes are presented based on the determined priority and any remaining attributes are not presented.

9. A non-transitory computer readable medium comprising instructions for presenting a report, the instructions, when executed by a processor operable to implement the steps of:
obtaining survey results to plurality of customer surveys for a predefined location over a data accumulation period, each customer survey including a plurality of attributes each having at least one weighting factor;
calculating a location average result for each of the plurality of attributes;
obtaining survey results to a plurality of peer surveys over the data accumulation period for at least one corresponding peer, each peer survey including a plurality of attributes;
calculating a peer average result for each of the plurality of attributes;
determining a peer difference score for each of the attributes as a difference between the location average result and the peer average result for the corresponding attribute;
determining a ranking score for each attribute based on a combination of the at least one weighting factor and the peer difference score; and
using the ranking score to determine a priority in which to present the attributes in a report.

10. The computer readable medium of claim 9, wherein the at least one weighting attribute includes an influence weight configured to weight the customer attribute in accordance with its importance.

11. The computer readable medium of claim 10, wherein the influence weight is determined based one or both of a Structural Equation or Path Analytical Model.

12. The computer readable medium of claim 9, wherein the at least one weighting attribute includes a business weight configured to weight the attribute in accordance with a predefined business attribute.

13. The computer readable medium of claim 12, wherein the business attributes are categorized as either a functional attribute or an emotional attribute.

14. The computer readable medium of claim 9, wherein the data accumulation period is three months.

15. The computer readable medium of claim 9, wherein the customer attributes are organized into a plurality of different focus areas and the attributes within one of the plurality of focus areas are presented based on the determined priority.

16. The computer readable medium of claim 9, wherein a predefined number of the attributes are presented based on the determined priority and any remaining attributes are not presented.
